(19) United States
(12) Patent Application Publication
(10) Pub. No.: US 2002/0074693 A1
(43) Pub. Date: Jun. 20, 2002

(54) Forming method of extrusion or jetting without thermal liquefaction

(76) Inventors: Yongnian Yan, Beijing (CN); Renji Zhang, Beijing (CN); Qingping Lu, Beijing (CN); Zhuo Xiong, Beijing (CN); Tingchum Shi, Tangshan (CN); Lifeng Chen, Beijing (CN); Yunyu Hu, Shanxi (CN); Weiguo Zheng, Beijing (CN); Li Wang, Beijing (CN)

Correspondence Address: MILDE, HOFFBERG & MACKLIN, LLP, SUITE 460, 10 BANK STREET, WHITE PLAINS, NY, 10606, US

(21) Appl. No.: 09/965,920

(22) Filed: Sep. 28, 2001

(30) Foreign Application Priority Data
Sep. 29, 2000 (CN) 00 1 24985.1

(51) Int. Cl. B29C 41/02

(52) U.S. Cl. 264/308

(57) ABSTRACT

The present invention relates to rapid prototyping technology and advances a new forming process of extrusion and jetting without thermal liquefaction. The present invention greatly simplifies the forming system, improves the quality and reduces the cost, protects many special materials, especially the dear nature of bioactive materials to adapt to making the tissue engineering scaffold in bioengineering.

### FIELD OF THE INVENTION

The present invention relates to a rapid prototyping process, especially the improvement on rapid prototyping process of direct deposition forming.

### BACKGROUND OF THE INVENTION

At present, all the rapid prototyping technology of materials droplet follows the same principle, namely heating the material to its melting point to obtain the molten state or fluid state (most of them are none-Newtonian fluid), then extruding or jetting the melted material through a nozzle to form liquid droplets or jet with continuous or impulsive pressure, controlling the droplets or jet to required position and depositing, transferring the heat of droplets or jet to the formed material and connecting to the formed shape through the diffusion, the material cooling at the same point to deposit a particle and form a 3D solid at the end. This is so called fused deposition forming. Based on this principle, there are many processes such as FDM of Stratasys, Genesys process, Model Maker process of Sanders, thermal jet process of 3D System Co. and Ballistic Particle Manufacturing process of BPM Co. Examples of the prior art process are described in U.S. Pat. Nos. 5,121,329, 5,340,433 and 5,260,009.

The prior art processes are shown in FIGS. 1 and 2. FIG. 1 is the most typical process. The filament 14 on the roller 15 is sent to the nozzle 11 and 12, and after being melted, it will be extruded out of the nozzle by the solid part and deposited on the desk 16. 13 is the model being made. FIG. 2 is the flow chart of the principle including the following steps. Heating the material to the temperature exceeds the melting point, after the liquid is obtained, pressing and extruding the material to force it to jet out of the nozzle, the droplets depositing, the temperature lowering, and the material solidifying, the 3D solid part is obtained on the desk.

The forming process such as FDM mentioned above has the following shortcomings. Because of the heating process, the present rapid prototyping processes face the problem of great residual stress. Additionally, a forming chamber, temperature controlling system and high temperature scanning system are needed. As a result, a complex system is required which is costly and has low forming quality. Additionally, since the material must be melted in the process of forming, the application of this process is limited for it does not adapt to forming the special material which is not heat resisting. For example, the tissue engineering scaffolds in bioengineering are fabricated with chemical vesicant and injection process at present. This process does not assure that the cavities in the scaffold are connected to each other, and cannot control the dimensions, shape, the distributing gradient of the cavity and form complicated shape. Though the method mentioned above such as FDM can control the distribution of cavity and form complicated shape, it cannot protect the precious special properties of bioactive material and meet the need of tissue engineering.

### SUMMARY OF THE INVENTION

The present invention aims at overcoming the shortage of the existing technologies, brings forward a forming process of extrusion and jetting without thermal liquefaction which greatly simplifies the fabricating system, improves the forming quality, reduces the cost and protects the precious special characters of many special materials, especially the bioactive materials and is fit for the manufacturing of the tissue engineering scaffold in bioengineering.

The present invention advances a new forming process of extrusion and jetting without thermal liquefaction including the following steps:

a. turning the material into liquid state or flow state without heating;

b. extruding the material of step (a) out of a nozzle to form droplets or jet;

c. depositing the droplets or jet of step (b) in a prescriptive path and

d. solidifying said droplets or jet deposits of step (c) to obtain said solid material.

The material in step (a) may be liquefied by the following procedures:

a. dissolving the material with menstruum (solvent), e.g. dissolving poly-lactic-acid with chloroform;

b. hydrolyzing the material with water, e.g. hydrolyzing the poly-lactic-acid or di-2-hydroxyethyl terephthalate with water;

c. adding glue or liquid (including melted additive or all sorts of fluid) to the material, e.g. mix the hexamethylene tetramine as additive with polyurethane;

d. bonding the material particles (micron or nanometer size) together to form colloidal liquid by the process of heating the none-forming material to the temperature exceeding the softening point or fusing point, and extrude or jet to form; and

e. breaking the hydrogen bonds, e.g. use a carbamide as blocking agent of hydrogen bonds to block the solidification of the hot gluten.

Droplets or jets are deposited by pressurizing material with high pressure gas or screw.

Liquid material (droplet or jet deposits) of the present invention may be solidified using the following procedures:

a volatizing menstruum, e.g. the menstruum chloroform volatilizes and leaves the solid of poly-lactic-acid;

b. vaporizing water, e.g. water vaporizes and leaves the solid of diethylene glycol terephthalate;

c. using jet solidifying agent at the same point or not the same point, e.g. jet fine sand or metal powder first, and then jet resin or benzene monosulfonic acid;

d. solidifying glue, e.g. the solidification of polylactic-acid;

e. promoting hydrogen bond formation, e.g., the large molecules of gluten recover the combining ability of hydrogen bond and

f. cooling the material to below the melting point

The method of the present invention may be used to obtain tissue engineering scaffold. The starting material is bioactive material. In a specific embodiment, polylactic acid and tricalcium phosphate can be used in constructing the tissue engineering scaffold.

### BRIEF DESCRIPTION OF THE DRAWINGS

FIG. 1 is a sketch map of a typical existing FDM process.

FIG. 2 is a flow chart of FDM process.

FIG. 3 is a flow chart of the extrusion, jetting forming process without heating liquefaction according to the present invention.

FIG. 4 is a mechanical construction sketch map of an example of the present invention.

FIG. 5 is a machine construction sketch map of the X-Y scanning system of FIG. 4.

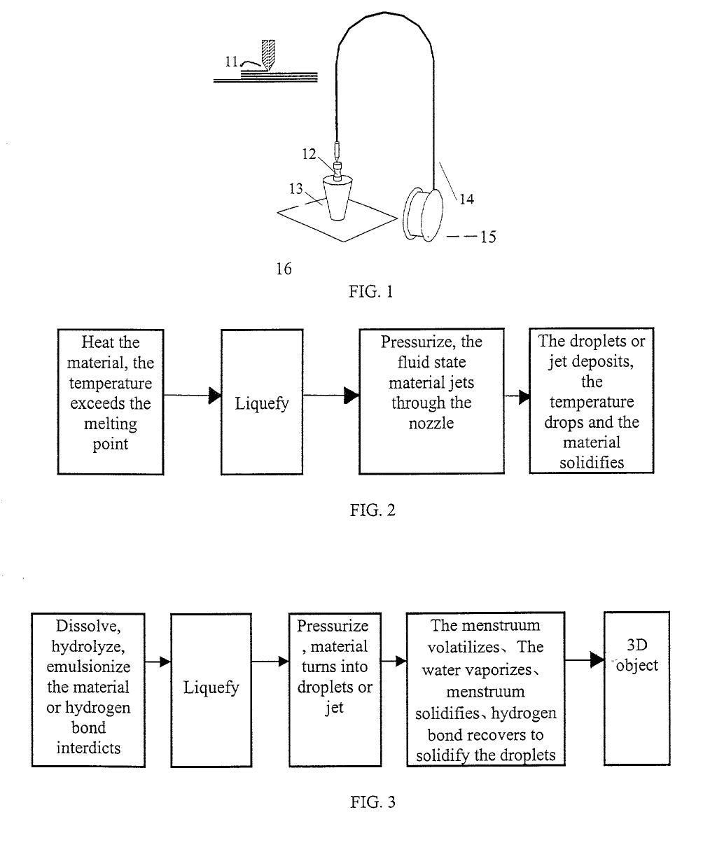

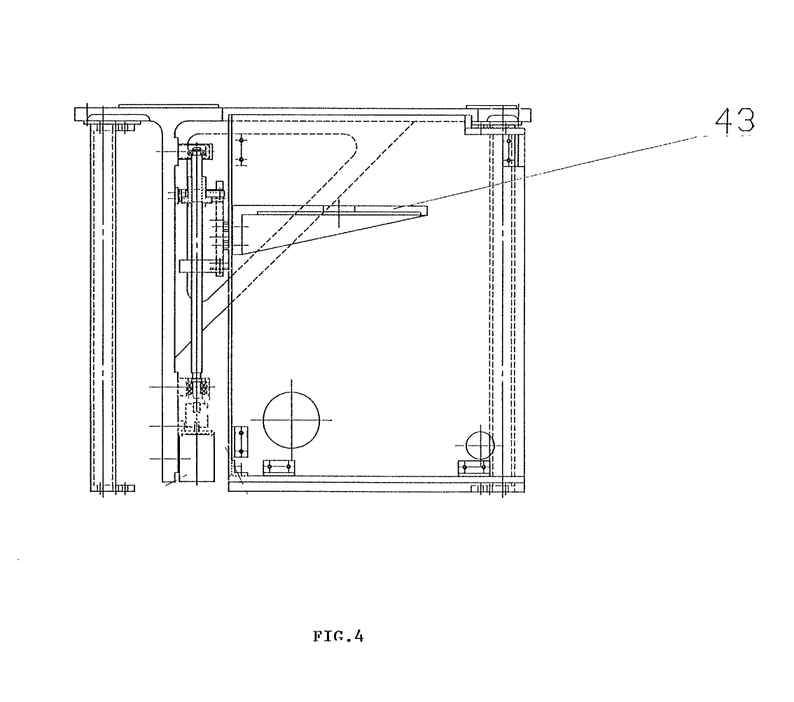

### DETAILED DESCRIPTION OF THE PREFERRED EMBODIMENTS

The non-heating liquefaction extrusion and jetting forming process of present invention involves the following steps:

1. The material is liquefied with chemical menstruum to dissolve, water to hydrolyze. The material is first prepared as powder of nanometer particles, then added in colloid menstruum to obtain flow state through emulsification process or by hydrogen bond interdiction. The material is liquefied without heating. The significance of the present invention is that it protects the special property of many special materials especially the bioactive materials. It is helpful in improving the precision in forming the final material and reducing the costs.

2. There is heat exchange when the droplet deposits on the surface of the prototype, and the droplet will join the prototype by diffuseness in traditional processes such as FDM. The material in the process of the present invention solidifies when the menstruum volatilizes, water vaporizes, or the menstruum or agglomerate (not the forming material itself) solidifies and results in the solidification of the material or the powder, there is formation of hydrogen bonds or jetting the curative at the same point to solidify the material. The fundamental point of this invention is that the solidification process is not carried out by lowering the temperature of the material to below the melting point. The material is liquefied with a nonheating method. The material is extruded or jetted under the pressure of gas or screw and becomes droplets or jet which deposits according to a certain path and forms a solid part after the menstruum is removed. When the material is extruded continuously, the material will have silkiness but still in droplet form.

3. The material used in present invention is pasty stock made by mixing and emulsifying the main forming material with menstruum, or dissolving, hydrolyzing and hydrogen bond interdiction. Since heating is not required or the temperature is not higher than the melting point of the main material, the disadvantageous infection to the special property of biomaterial is avoided. Because there is no heating process, this forming process is very fit for the making of tissue engineering scaffold.

Scaffold is one of the three essentials of tissue engineering. The other two essentials are target cells and growth factor that are working dependent on the scaffold. The porous scaffold provides a necessary supporting environment for the cells to crawl and multiply therefore realizes the three-dimensional culture and enables the reconstructing of bone, blood vessel and kidney with special structure.

The present invention reengineers the geometrical model of scaffold according to the anatomical data of human apparatus. Since the data model comes from the anatomical data of computerized tomography of animal or human apparatus, the process not only realizes the individuation service, but also anastomoses the original organ at both dimension and shape. The production process of rapid prototype machine is controlled by data model, and the material is extruded layer by layer. Because the nozzle diameter and jetting speed can be controlled accurately, high precision production is realized geometrically. It is not necessary to make mould and to fabricate by perfusion process.

4. The present invention is very fit for the rapid forming of tissue engineering material with bioactive material. Since heating is not needed, the bioactive material should not to be destroyed in the forming process. The present invention is also fit for the extrusion or jetting of other materials such as polymer, macromolecule and plastic.

The liquid droplets mentioned above will connect to each other in continuous jetting process, namely will form jet in continuous extrusion. The extrusion jetting belongs to this type, and the above analysis adapts to this situation.

The extrusion or jetting forming process without heating liquefaction according to the present invention shown in FIG. 3 includes the following steps:

1. The material is liquefied without heating;

2. The material is extruded or jetted at normal temperature through the nozzle under the pressure and forms droplets or jet;

3. The droplets or jet deposits in a controlled path and solidifies when the menstruum is removed and becomes the solid part.

The present invention can be realized by the existing MEM-300-II melted extrusion manufacturing equipment with none heating nozzle extruding at normal temperature. The sizing agent is fed to the inner chamber of the nozzle by feeding organization and continuously or discretely extruded under the pressure and the control or the numerical control system.

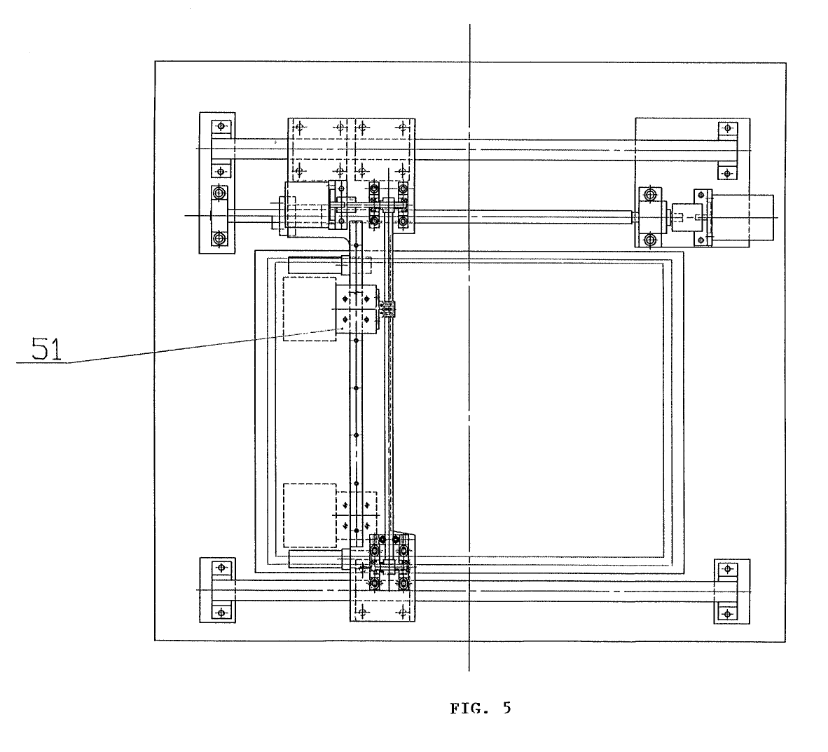

The MEM-300 machine includes framework, X, Y and Z guide rails on the framework, nozzle set, driving and control circuit, forming room and industrial computer shown in FIG. 4. In FIG. 4, the worktable 43 moves from above to below driven by the Z shaft so that the nozzle can keep a constant target distant to the forming surface. FIG. 5 is the X-Y scanning system sketch map of FIG. 4. In FIG. 5, the nozzle 51 moves in a horizontal plane together with X shaft along the Y shaft to realize the scanning movement in the whole plane.

Since the nozzle heating set, temperature control system and the heating system of the forming room are taken out, the cost of the hardware is reduced. The other advantage of the normal temperature extrusion process is less thermal stress of the prototype, and greater ease in obtaining the precision of dimension and shape.

The detailed method of the extrusion and jetting process with the mentioned equipment of present invention is:

First, create a CAD model of the object, then slice and plan the scanning route with the control software developed by the Center of Laser Rapid Forming of Tsinghua University. Load the material into the feeding set, connect the pressure gas pipe and turn on the air compressor.

Start up the control software. The nozzle will scan the contour and fill in the inner space along the planed route under the control of the control software.

In order to get rid of the menstruum rapidly from the forming material and solidify, the forming chamber should keep a low temperature with some method such as dry ice.

### EXAMPLES

The examples of the forming material and its solidification method of present invention are listed below:

### Example 1

Dissolve the forming material poly-lactic-acid with chloroform to get the sizing material, then put the material inside the chamber of the nozzle and forming with jetting. During the jetting process, the chloroform volatilizes and the material solidifies.

### Example 2

Dissolve the ABS with acetone and form by extrusion or jetting process.

### Example 3

Mix the hydroxyapatite nanometer powder, collagen and dissolved poly-lactic-acid together and extrude or jet the sizing agent through nozzle to form.

The specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

Various references are cited herein, the disclosures of which are incorporated by reference in their entireties.

What is claimed is:

1. A process of forming without thermal liquefaction a solid material, comprising:
a. turning the material into liquid state or flow state without heating;
b. extruding the material of step (a) out of a nozzle to form droplets or jet;
c. depositing the droplets or jet of step (b) in a prescriptive path and
d. solidifying said deposited droplets or jet to obtain said solid material.

2. The process according to claim 1, wherein the material is liquefied in step (a) by dissolving the material with solvent.

3. The process according to claim 1, wherein the material is liquefied in step (a) by dissolving the material with water.

4. The process according to claim 1, wherein the material is liquefied in step (a) by mixing the material with glue or liquid.

5. The process according to claim 1, wherein the material is liquefied in step (a) by bonding micron or accessory material particles together to form colloidal liquid by heating said material to a temperature exceeding said melting point and extruding or jetting said material.

6. The process according to claim 1, wherein the material is liquefied in step (a) by interdicting hydrogen bonds of said material.

7. The process according to claim 1, wherein the droplet or jet deposits are solidified in step (d) by volatilizing solvent from said droplet or jet deposits.

8. The process according to claim 1, wherein the droplet or jet deposits are solidified in step (d) by vaporizing water from said droplet or jet deposits.

9. The process according to claim 1, wherein the droplet or jet deposits are solidified in step (d) by jetting a curative at the same or different point.

10. The method according to claim 1, wherein the droplet or jet deposits are solidified in step (d) by forming hydrogen bonds.

11. The method according to claim 1, wherein the droplet or jet deposits are solidified by solidifying agglomerate or solvent within said deposits.

12. The process according to claim 1, wherein in step (b) the material is extruded by pressurizing methods.

13. The process according to claim 12, wherein the pressurizing methods are pressure gas or screw pressurizing.

14. A process for obtaining tissue engineering scaffold comprising:
a. turning bioactive material into liquid state or flow state without heating;
b. extruding the material of step (a) out of a nozzle to form droplets or jet;
c. depositing the droplets or jet of step (b) in a prescriptive path and
d. solidifying said deposited droplets or jet to obtain said solid material.

15. The process according to step (a), wherein said material used in step (a) is selected from the group consisting of polylactic acid and tricalcium phosphate.
